(19) United States
(12) Patent Application Publication
(10) Pub. No.: US 2011/0194457 A1
(43) Pub. Date: Aug. 11, 2011

(54) Identification Device for Identifying The End of a Network Cable and Network System Having The Same

(76) Inventor: Chih-Fu HWANG, Taipei City (TW)

(21) Appl. No.: 12/787,433

(22) Filed: May 26, 2010

(30) Foreign Application Priority Data
Feb. 10, 2010 (TW) 099104161

(51) Int. Cl. H04L 12/28

(52) U.S. Cl. 370/254

(57) ABSTRACT

An identification device for identifying the end of a network cable comprises a transmitting unit, an address-storing unit, and a control unit. The transmitting unit is electrically connected to a switch; the address-storing unit is electrically to the transmitting unit, the address-storing unit storing a MAC address; and a control unit is electrically connected to the address-storing unit. When the identification device receives a request signal, the control unit delivers the MAC address to the transmitting unit. Then the MAC address is delivered to a server via the switch.

### BACKGROUND OF THE INVENTION

1. Field of the Invention

The present invention relates to an identification device and network system having the same; more particularly, the present invention relates to an identification device for identifying the end of a network cable and network system having the same.

2. Description of the Related Art

The wiring of a network cable is a necessary task in modern buildings. In an office building, for instance, because of complications of the installation of a cable, the location of the cable may be clear while recently installed. As the time goes by, however, the network cable becomes tangled with others and difficult to identify. Furthermore, if a computer is moved, the corresponding relations between the cables and the location of the computer are changed, so it is not easy to determine the actual location of each cable.

In a prior art, the wiring of the network cable is recorded by hand (making a detailed list, for example), but it usually can't be updated timely after the wiring is changed. When a line is disconnected, it is necessary to test the connection of each cable by hand, which wastes time and labor.

Therefore, there is a need to provide an identification device for identifying the end of a network cable and network system having the same to mitigate and/or obviate the aforementioned problems.

### SUMMARY OF THE INVENTION

It is an object of the present invention to provide an identification device for identifying the end of a network cable.

It is another object of the present invention to provide a network system having the identification device for identifying the end of a network cable.

To achieve the abovementioned object, the identification device for identifying the end of a network cable of the invention comprises a transmitting unit, an address-storing unit, and a control unit. The transmitting unit is electrically connected to a switch; the address-storing unit is electrically connected to the transmitting unit, the address-storing unit storing a MAC address; and a control unit is electrically connected to the address-storing unit. When the identification device receives a request signal, the control unit delivers the MAC address to the transmitting unit. Then the MAC address is delivered to a server via the switch.

To achieve the abovementioned another object, the network system of the invention comprises the identification device for identifying the end of a network cable.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates an environmental framework drawing of an identification device for identifying the end of a network cable of the present invention.

FIG. 2 illustrates a flow chart of an identification device for identifying the end of a network cable of the present invention.

### DETAILED DESCRIPTION OF THE PREFERRED EMBODIMENT

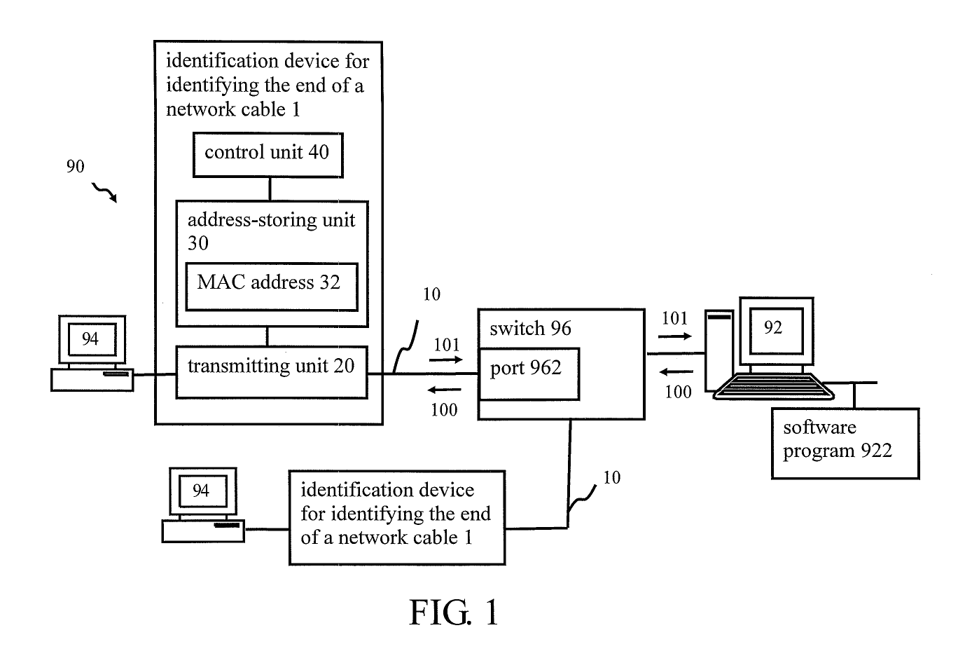

Please refer to FIG. 1, which illustrates an environmental framework drawing of an identification device for identifying the end of a network cable of the present invention. The identification device for identifying the end of a network cable 1 is used for a network system 90. In the embodiment, the network system 90 is an Ethernet system. The network system 90 comprises a server 92 and a switch 96, wherein the server 92 is electrically connected to the switch 96. The server can send a request signal 100 to the identification device for identifying the end of a network cable 1. The identification device for identifying the end of a network cable 1 can help a using organization (a company building, for example) to quickly acquire information on each identification device for identifying the end of a network cable 1 and/or its real location of the corresponding user computer 94 for the convenience of maintaining and managing of internet wiring. The identification device for identifying the end of a network cable 1 mainly comprises a transmitting unit 20, an address-storing unit 30, and a control unit 40.

The transmitting unit 20 is electrically connected to the switch 96 via the cable. The transmitting unit 20 transmits information among the control unit 40, the server 92, and the user computer 94. When the identification device for identifying the end of a network cable 1 is connected to the user computer 94, the user computer 94 can transmit or receive information via the transmitting unit 20. It needs to be noted that the identification device for identifying the end of a network cable 1 of the invention does not need to be electrically connected to the user computer 94, and it can achieve the effect of positioning the internet cable. In the condition of being disconnected from the user computer, the transmitting unit 20 of the identification device for identifying the end of a network cable 1 can receive the request signal 100 from the server, and send a respond signal 101 transmitting a MAC address to the server 92 by itself, wherein the MAC address 32 is an address format of MAC (Media Access Control) of an Ethernet system.

The address-storing unit 30 is electrically connected to the transmitting unit 20. The address-storing unit 30 stores the MAC address 32. By the address format of MAC of Ethernet in existence, the meaning of each of the existing six bytes is redefined to separate the MAC address 32 of the address-storing unit 30 from a MAC address of a network card in the user computer 94. For example, the MAC address format could be: XX: XX: XX: XX: XX: XX. The range of each “X” could be 0˜9 or A˜F.

In the embodiment, the six bytes of the MAC address 32 can be an identification number, a geographic location number, a building number, a floor number, a partition number, and a location number in sequence.

Each MAC address 32 stored in the address-storing unit 30 of the identification device for identifying the end of a network cable 1 is different, wherein the first byte of the identification number is a specific purpose MAC address format for cable identification, not the same as the first byte of the network card in any brand or type to the use of identifying the identification device for identifying the end of a network cable 1. The second to sixth bytes present the location from large to small area, for example, but the meanings of the second byte to the sixth byte are not limited to the above-mentioned description.

Therefore, the server 92 can receive two kinds of MAC address respectively from the user computer 94 and the identification device for identifying the end of a network cable 1, and then they will be identified via the software program 922 in the server 92.

The control unit 40 is electrically connected to the address-storing unit 30. When the identification device for identifying the end of a network cable 1 receives the request signal 100 from the server 92, the control unit 40 sends the MAC address 32 to the switch 20, and then sends it to the server 92 via the switch 96.

The control unit 40 has the function of an IP address that can be set and network response protocol. In the embodiment, the network response protocol meets an ARP (Address Resolution Protocol), which is a standard check and response method. The response information comprises the MAC address 32 and the IP address. However, the network response protocol can also comprise another network signal format with response ability.

When the identification device for identifying the end of a network cable 1 receives the request signal 100, the control unit 40 sends the MAC address 32 in the address-storing unit 30, and the IP address in the control unit 40. The MAC address 32 and the IP address are sent back to the server 92 via the transmitting unit 20, which is connected to the network.

The transmitting unit 20, the address-storing unit 30, or the control unit 40 can be a chip respectively, or the function of the transmitting unit 20, the address-storing unit 30, or the control unit 40 is integrated into a single chip.

The identification device for identifying the end of a network cable 1 can further comprise an end box (not shown in the figures). The transmitting unit 20, the address-storing unit 30, and the control unit 40 are in the end box. The end box can be electrically connected to the user computer 94 via a cable, and can be electrically connected to the switch 96 via another cable.

However, when the transmitting unit 20, the address-storing unit 30, and the control unit 40 are very small (integrated into a chip, for example), the transmitting unit 20, the address-storing unit 30, and the control unit 40 can be embedded in a cable.

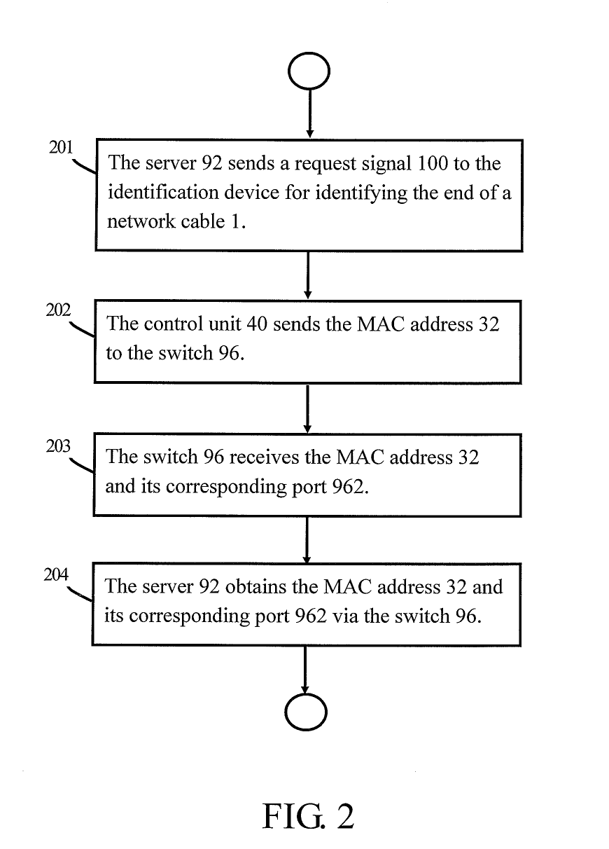

Please refer to FIG. 1 and FIG. 2 together. FIG. 2 illustrates a flow chart of an identification device for identifying the end of a network cable. It shows real operation of the identification device for identifying the end of a network cable 1 of the invention.

Step 201: The server 92 sends a request signal 100 to the identification device for identifying the end of a network cable 1.

The server 92 sends the request signal 100 to call each identification device for identifying the end of a network cable 1. Regarding the timing of the server 92 sending the request signal 100, the request signal 100 can be sent by the server at predetermined intervals of time, sent at predetermined times, or sent manually.

Step 202: The control unit 40 sends the MAC address 32 to the switch 96.

When the identification device for identifying the end of a network cable 1 receives the request signal 100, the control unit sends a response signal 101 such that the MAC address 32 is sent to the switch 96.

Step 203: The switch 96 receives the MAC address 32 and its corresponding port 962.

When the MAC address 32 of the identification device for identifying the end of a network cable 1 is sent to the switch 96, the switch 96 records the MAC address 32 and the port 962 corresponding to the switch 96 to establish the matching information of the port 962 and the MAC address 32 of the switch 96. At this time, the information of the MAC address 32 represents the location of the end of the network cable. In the embodiment, the switch 96 needs only to receive and record the MAC address 32.

Step 204: The server 92 obtains the MAC address 32 and its corresponding port 962 via the switch 96.

In the embodiment, the server 92 uses another standard protocol, SNMP (Simple Network Management Protocol), to obtain related information on the switch 96. Then it can use the software program 922 to establish positioning information of the wiring cable to identify the actual location of the identification device for identifying the end of a network cable 1.

Although the present invention has been explained in relation to its preferred embodiments, it is to be understood that many other possible modifications and variations can be made without departing from the spirit and scope of the invention as hereinafter claimed.

What is claimed is:

1. An identification device for identifying the end of a network cable used for a network system, the network system comprising a server and a switch, the server being electrically connected to the switch; the server can send a request signal to the identification device for identifying the end of a network cable, the identification device for identifying the end of a network cable comprising:
a transmitting unit, the transmitting unit being electrically connected to the switch;
an address-storing unit, the address-storing unit being electrically connected to the transmitting unit, the address-storing unit storing a MAC address; and
a control unit, the control unit being electrically connected to the address-storing unit; when the identification device receives the request signal, the control unit delivers the MAC address to the transmitting unit, and then the MAC address is delivered to the server via the switch.

2. The identification device for identifying the end of a network cable as claimed in claim 1, wherein the MAC address comprises six bytes, which are selected from the following: an identification number, a geographic location number, a building number, a floor number, a partition number, and a location number.

3. The identification device for identifying the end of a network cable as claimed in claim 2, wherein the identification number is the first byte of the MAC address.

4. The identification device for identifying the end of a network cable as claimed in claim 2, wherein the transmitting unit, the address-storing unit, or the control unit is a chip.

5. The identification device for identifying the end of a network cable as claimed in claim 4, wherein the chip is embedded in a cable.

6. The identification device for identifying the end of a network cable as claimed in claim 1, further comprising an end box, the transmitting unit, the address-storing unit, and the control unit being in the end box.

7. The identification device for identifying the end of a network cable as claimed in claim 1, wherein the control unit meets an address resolution protocol.

8. The identification device for identifying the end of a network cable as claimed in claim 1, wherein the request signal received from the identification device for identifying the end of a network cable is sent by the server at a predetermined interval of time, at a predetermined time, or manually.

9. The identification device for identifying the end of a network cable as claimed in claim 1, wherein the network system is an Ethernet system.

10. A network system, which comprises an identification device for identifying the end of a network cable as claimed in claim 1.
